(19) United States
(12) Patent Application Publication
(10) Pub. No.: US 2018/0343783 A1
(43) Pub. Date: Dec. 6, 2018

(54) Drag Plate Attachment for Skid Steer Machines

(71) Applicant: Bruce Lee Ayers, Enid, OK (US)

(72) Inventor: Bruce Lee Ayers, Enid, OK (US)

(21) Appl. No.: 15/615,327

(22) Filed: Jun. 6, 2017

(51) Int. Cl. A01B 31/00; E02F 3/815

(52) U.S. Cl. CPC A01B 31/00; A01B 45/00; E02F 3/815

(57) ABSTRACT

A drag plate attachment for skid steer machines includes a coupling body, a drag plate body, and a plurality of flexible connectors. The coupling body mounts the drag plate attachment to a skid steer machine as the drag plate body is pivotably connected to coupling body by the plurality of flexible connectors. The drag plate body includes a front beveled end, a rear flat end, a plurality of first cross beams, and a plurality of second cross beams to efficiently distribute a quantity of lose materials throughout a lot or an area. Due to the configuration of the coupling body, the drag plate body, and the flexible connectors, the drag plate attachment distributes a large amount of lose material with greater precision than a heavier machine or attachment, and with greater speed than a worker with hand tools.

### FIELD OF THE INVENTION

The present invention relates generally to a skid steer attachment. More specifically, the present invention is a drag plate attachment for skid steer machines so that material can be distributed with greater precision than a heavier machine and with greater speed than a worker with hand tools.

### BACKGROUND OF THE INVENTION

Conventionally media/material such as dirt, gravel, mulch, and top soil is dumped on the work site near its destination by a dump truck or other heavy equipment. The media/material is then distributed by hand using wheelbarrows, carts, and hand tools such as shovels and rakes. This process is time consuming and can require many people to complete the proper distribution in a timely manner. Large machines such as front loaders or bulldozers cannot achieve the necessary subtle changes in depth and grade of media without an exorbitant amount of time or uncommon skill.

It is therefore an object of the present invention to provide a drag plate attachment for skid steer machines. The present invention comprises a coupling unit and a drag plate that are connected by flexible connectors. The present invention is designed to operate with a skid steer loader with compulsory operating skills. The flexible connectors allow the drag plate to move along uneven surfaces without biting into the ground while the coupling unit allows the drag plate to be moved as the skid steer attachment. The drag plate can be made in various dimensions such as, small and large designs, to accommodate different size lots or areas. The present invention allows a large amount of lose material to be distributed with greater precision than a heavier machine or attachment, and with greater speed than a worker with hand tools, thereby improving the conventional method of material distribution.

### BRIEF DESCRIPTION OF THE DRAWINGS

FIG. 1 is a perspective view of the present invention.

FIG. 2 is a side view of the present invention.

FIG. 3 is a perspective view of the drag plate body of the present invention.

FIG. 4 is a side cross-sectional view of the drag plate body of the present invention, showing the acute angle between the front beveled end and the rear flat end.

FIG. 5 is a side cross-sectional view of the drag plate body of the present invention, showing the triangular cross-sectional profile for each of the plurality of first cross beams.

FIG. 6 is a top view of the drag plate body of the present invention, showing the three different skeletal sections.

FIG. 7 is a perspective view of the coupling body of the present invention.

FIG. 8 is another perspective view of the present invention.

### DETAIL DESCRIPTIONS OF THE INVENTION

All illustrations of the drawings are for the purpose of describing selected versions of the present invention and are not intended to limit the scope of the present invention.

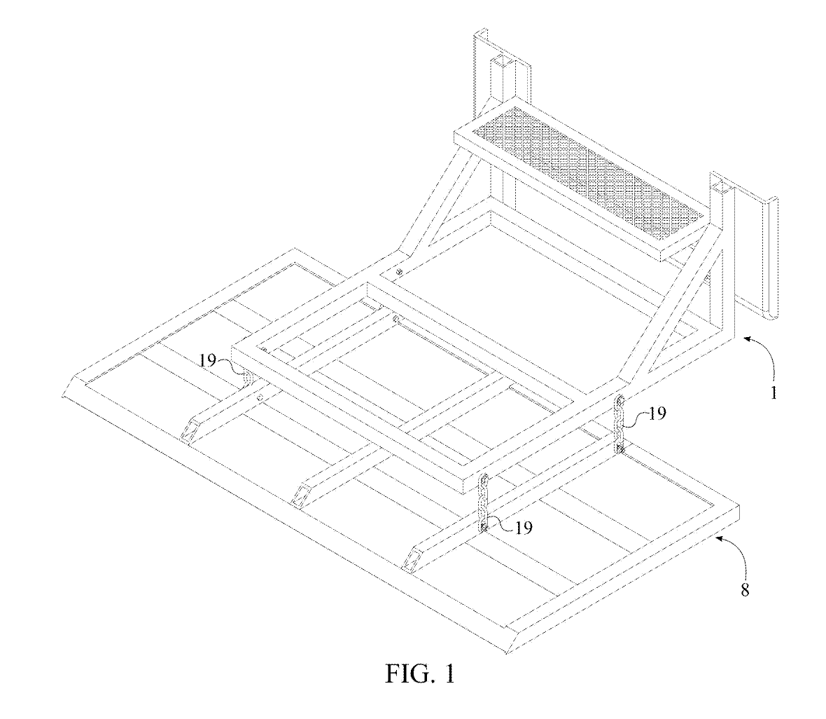

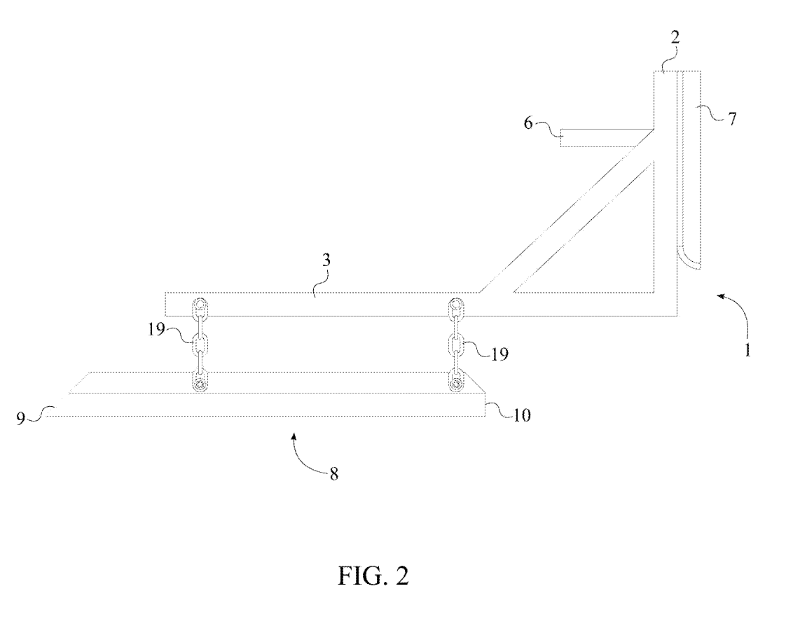

The present invention is a drag plate attachment for skid steer machines so that an operator can distribute a quantity of lose materials over a designated surface. The quantity of lose materials that is distributed by the present invention can include, but is not limited to, dirt, gravel, mulch, and top soil. The present invention provides an improved apparatus over conventional material spreading methods as the present invention distributes the quantity lose materials with greater precision than a heavier machine or attachment and with greater speed than a worker with hand tools. As shown in FIG. 1-2, the present invention comprises a coupling body 1, a drag plate body 8, and a plurality of flexible connectors 19. In reference to the general configuration of the present invention, the coupling body 1 mounts the present invention to a skid steer machine. The drag plate body 8 that distributes the quantity of lose materials is pivotably connected to the coupling body 1 by the plurality of flexible connectors 19.

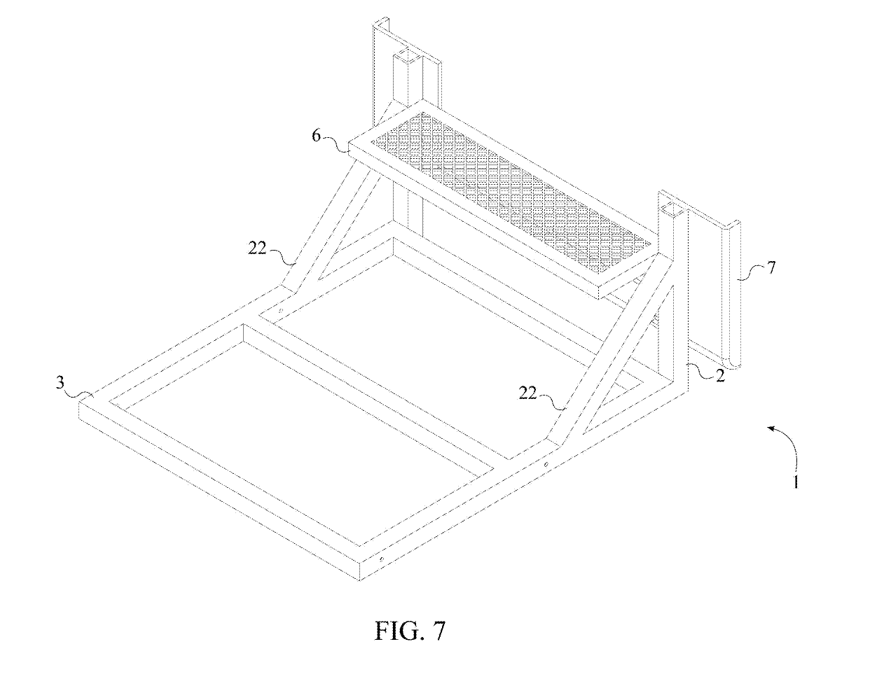

The coupling body 1 that mounts the present invention to the skid steer machine and functions as a platform for the drag plate body 8 to be connected. The coupling body 1 comprises a first frame 2, a second frame 3, a step platform 6, and a skid steer mounting plate 7. In reference to FIG. 2 and FIG. 7, the first frame 2 is terminally and perpendicularly connected to the second frame 3. The first frame 2 and the second frame 3 collectively delineate a L-shaped form for the coupling body 1. The skid steer mounting plate 7 that mounts the present invention to the skid steer machine is adjacently connected to the first frame 2. The step platform 6, which assists an operator to move in and out of the skid steer machine, is adjacently connected to the first frame 2 and is positioned opposite of the skid steer mounting plate 7. In other words, the skid steer mounting plate 7 and the step platform 6 are oppositely positioned of each other about the first frame 2. In order to provide proper clearance and obstruction free height for an operator, the step platform 6 is positioned atop the second frame 3. As a result, an operator can easily move in and out of the skid steer machine by stepping on the step platform 6. Since the skid steer mounting plate 7 is connected to the first frame 2, the first frame 2 functions as a fixed end of the coupling body 1 while the second frame 3 functions as a free end thus extending away from the skid steer machine. As a result, the drag plate body 8 can be pivotably connected to the second frame 3 by the plurality of flexible connectors 19, wherein the drag plate body 8 and the step platform 6 are oppositely positioned of each other about the second frame 3.

In reference to FIG. 2, the step platform 6 is generally formed into a rectangular shape and positioned away from the second frame 3 so that the step platform 6 does not interact with the quantity of lose material when the present invention is utilized. The step platform 6 comprises an outer structural frame and an inner anti-slip step panel, wherein the outer structural frame is perimetrically connected around the inner anti-slip step panel. More specifically, the outer structural frame provides stability for the step platform 6 thus tolerating the weight of an operator during usage. The inner anti-slip step panel provides a safe surface area for an operator to step in and out of the skid steer machine without slipping or falling.

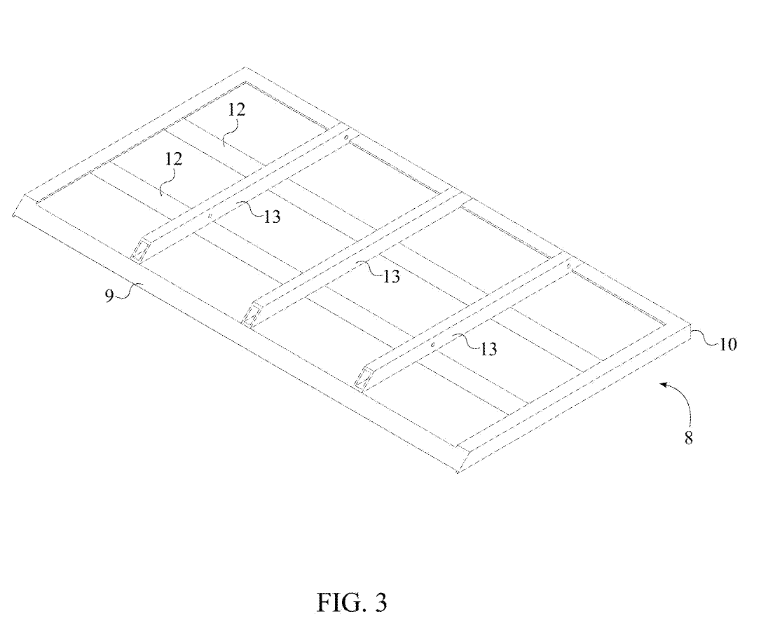

The drag plate body 8 allows the present invention to precisely distribute the quantity of lose materials. The drag plate body 8 is preferably formed into a rectangular shape for optimal usage; however, the drag plate body 8 can be formed into any other geometric shape or organic shape within the present invention. In reference to FIG. 3, the drag plate body 8 comprises a front beveled end 9 and a rear flat end 10. The front beveled end 9 and the rear flat end 10 are oppositely positioned of each other along the drag plate body 8 as the front beveled end 9 and the rear flat end 10 are oriented with each other at an acute angle 11. More specifically, the front beveled end 9 allows the drag plate body 8 to easily dig into the quantity of lose material so that excess lose material can go under or over the front beveled end 9 during the usage of the present invention. Then, the rear flat end 10 can push off any excess lose material, creating an even surface area.

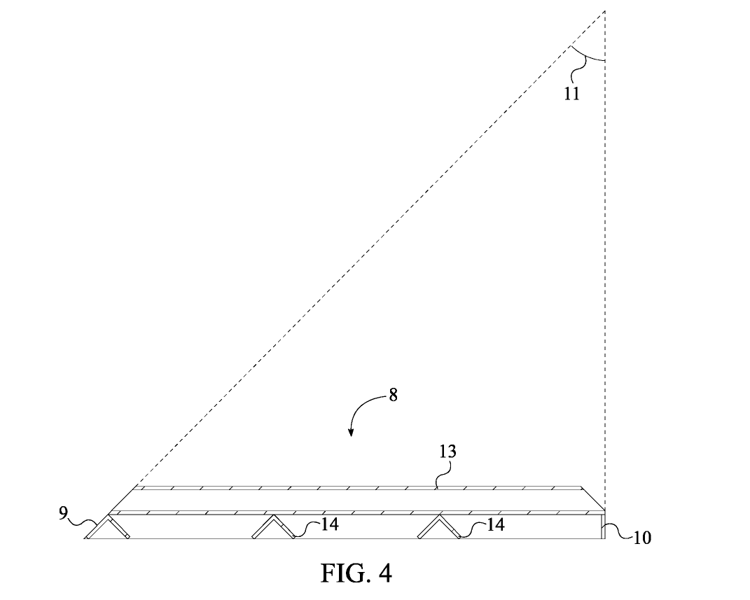

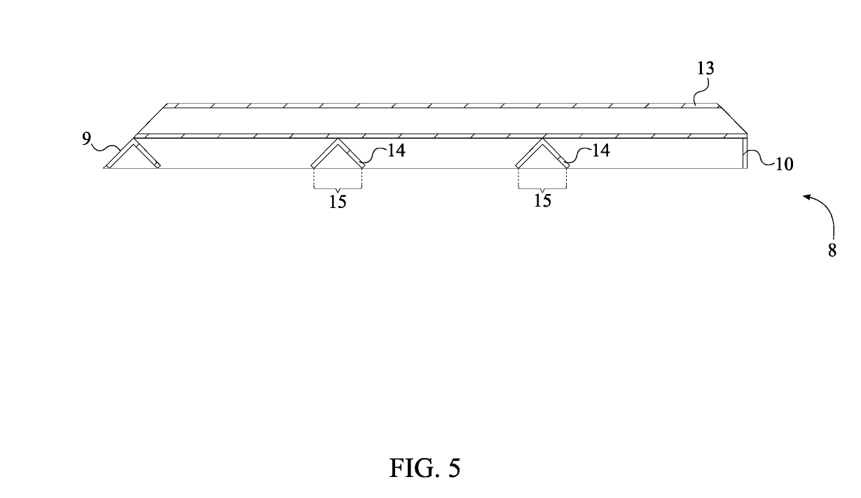

The drag plate body 8 further comprises a plurality of first cross beams 12 and a plurality of second cross beams 13. In reference to FIG. 3-5, the plurality of first cross beams 12 is positioned parallel to the front beveled end 9 and the rear flat end 10, extending the plurality of first cross beams 12 from a left side of the drag plate body 8 to a right side of the drag plate body 8. The plurality of second cross beams 13 is perpendicularly positioned to the plurality of first cross beams 12 thus extending from front beveled end 9 to the rear flat end 10. Additionally, each of the plurality of first cross beams 12 comprises a triangular cross-sectional profile 14 that is oriented normal to a length of each first cross beam. Resultantly, a base 15 of the triangular cross-sectional profile 14 is positioned parallel to a length of each of the plurality of second cross beams 13 and provides an opening for each of the plurality of second cross beams 13. A first sidewall of the triangular cross-sectional profile 14 is positioned parallel to the front beveled edge. A second sidewall of the triangular cross-sectional profile 14 and the first sidewall are oriented at an acute angle or right angle with each other. Due to the configuration of the base 15, the first sidewall, and the second sidewall, each of the plurality of first cross beams 12 is able to combine the functionality of the front beveled end 9 and the rear flat end 10.

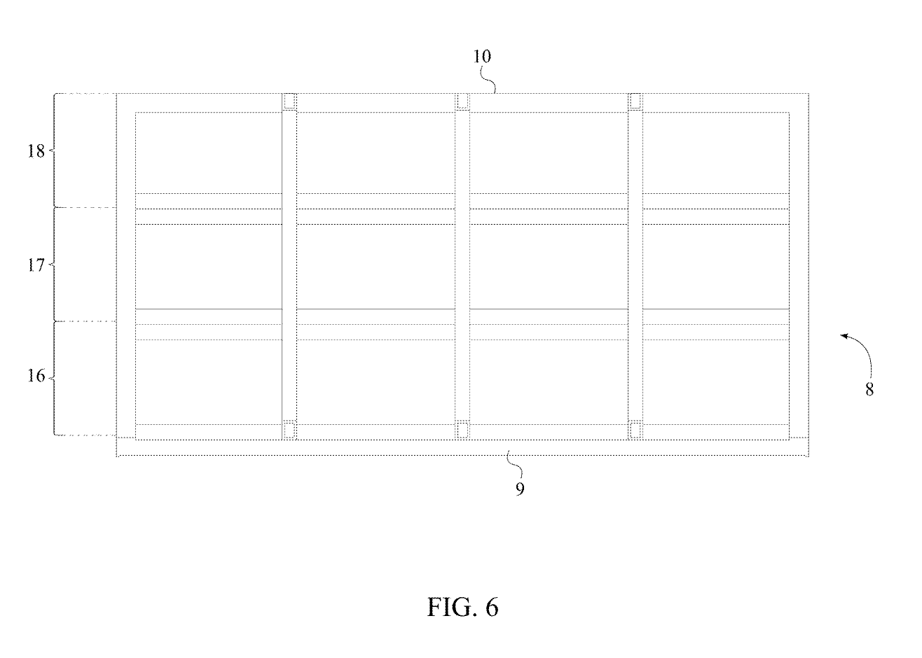

The drag plate further comprises a front skeletal section 16, an intermediary skeletal section 17, and a rear skeletal section 18. In reference to FIG. 6, the front skeletal section 16 is adjacently connected to the intermediary skeletal section 17 and positioned in between the intermediary skeletal section 17 and the front beveled end 9. The rear skeletal section 18 is adjacently connected to the intermediary skeletal section 17 and positioned in between the intermediary skeletal section 17 and the rear flat end 10. In other words, the front skeletal section 16 and the rear skeletal section 18 are oppositely positioned of each other about the intermediary skeletal section 17 in such a way that the front skeletal section 16, the intermediary skeletal section 17, and the rear skeletal section 18 are positioned in between the front beveled end 9 and the rear flat end 10. The configuration of the front skeletal section 16, the intermediary skeletal section 17, and the rear skeletal section 18 delineate the preferred rectangular shape of the drag plate body 8 and provide a plurality of opening for the drag plate body 8. When the plurality of first cross beams 12 pushes the quantity of lose materials, the plurality of openings allows excess lose material that travels over the plurality of first cross beams 12 to drop back into the designated surface. In other words, the present invention minimizes the pressure created by the quantity of lose materials through the plurality of opening as excess lose material never gets collected by the drag plate body 8. Since the drag plate body 8 is pivotably connected to the coupling body 1 by the plurality of flexible connectors 19, the plurality of openings also reduces the pressure absorb by the plurality of flexible connectors 19 and improves the reliability of the present invention.

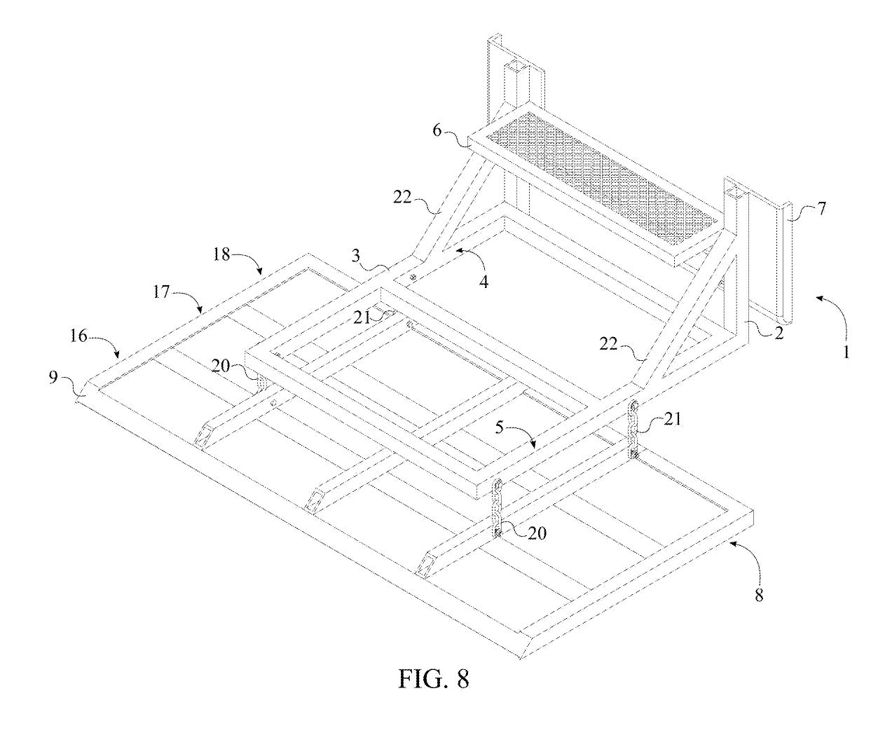

In reference to FIG. 8, the plurality of flexible connectors 19 comprises a set of front connectors 20 and a set of rear connectors 21 in order to perimetrically connect the drag plate body 8 to the coupling body 1. More specifically, the set of rear connectors 21 is positioned in between a proximal section 4 of the second frame 3 and the rear skeletal section 18 of the drag plate body 8. The set of front connectors 20 is positioned in between a distal section 5 of the second frame 3 and the front skeletal section 16 of the drag plate body 8, a five-link chain is used as the preferred embodiment for each of the plurality of flexible connectors 19 within the present invention. However, the present invention can use any other types of flexible fasteners as the plurality of flexible connectors 19 as long as the drag plate body 8 can be connected to the coupling body 1 without limiting its functionality and structural integrity.

The set of front connectors 20 and the set of rear connectors 21 are terminally mounted to the coupling body 1 and the drag plate body 8 by nut and bolt fasteners so that an operator or a service mechanic can easy disassemble the present invention for repairs and part replacements. Additionally, each nut and bolt fastener comprises at least one plate washer that is positioned adjacent each of the plurality of flexible connectors 19. The plate washer provides a flat surface area for each nut and bolt fastener to rest upon during the installation process and improves the structural integrity of the nut and bolt fasteners as each of the plurality of flexible connectors 19 does not rotate about the nut and bolt fasteners.

In reference to FIG. 7-8, the present invention further comprises a pair of supporting arms 22. The pair of supporting arms 22 is oppositely positioned of the skid steer mounting plate 7 about the first frame 2 and angularly connected in between the first frame 2 and the second frame 3. More specifically, the pair of supporting arms 22 provides additional structural support for the connection points of the first frame 2 and the second frame 3, improving the structural integrity of the coupling body 1.

Although the invention has been explained in relation to its preferred embodiment, it is to be understood that many other possible modifications and variations can be made without departing from the spirit and scope of the invention as hereinafter claimed.

What is claimed is:

1. A drag plate attachment for skid steer machines comprises:
a coupling body;
a drag plate body;
a plurality of flexible connectors;
the coupling body comprises a first frame, a second frame, a step platform, and a skid steer mounting plate;
the first frame being terminally and perpendicularly connected to the second frame;
the skid steer mounting plate being adjacently connected to the first frame;
the step platform being adjacently connected to the first frame;
the skid mounting plate and the step platform being oppositely positioned of each other about the first frame;
the step platform being positioned atop the second frame;
the drag plate body being pivotably connected to the second frame by the plurality of flexible connectors; and
the drag plate body and the step platform being oppositely positioned of each other about the second frame.

2. The drag plate attachment for skid steer machines as claimed in claim 1 comprises:
the drag plate body comprises a front beveled end and a rear flat end;
the front beveled end and the rear flat end being oppositely positioned of each other along the drag plate body; and
the front beveled end and the rear flat end being oriented with each other at an acute angle.

3. The drag plate attachment for skid steer machines as claimed in claim 2 comprises:
the drag plate body further comprises a plurality of first cross beams and a plurality of second cross beams;
the plurality of first cross beams being positioned parallel to the front beveled end and the rear flat end; and
the plurality of second cross beams being perpendicularly positioned to the plurality of first cross beams.

4. The drag plate attachment for skid steer machines as claimed in claim 2 comprises:
the drag plate body further comprises a plurality of first cross beams;
a triangular cross-sectional profile being oriented normal to a length of each first cross beam; and
a base of the triangular cross-sectional profile being positioned parallel to a length of each second cross beams.

5. The drag plate attachment for skid steer machines as claimed in claim 1 comprises:
the drag plate body comprises a front skeletal section, an intermediary skeletal section, and a rear skeletal section;
the front skeletal section being adjacently connected to the intermediary skeletal section;
the rear skeletal section being adjacently connected to the intermediary skeletal section; and
the front skeletal section and the rear skeletal section being oppositely positioned of each other about the intermediary skeletal section.

6. The drag plate attachment for skid steer machines as claimed in claim 1 comprises:
the plurality of flexible connectors comprises a set of front connectors and a set of rear connectors;
the set of rear connectors being positioned in between a proximal section of the second frame and a rear skeletal section of the drag plate body; and
the set of front connectors being positioned in between a distal section of the second frame and a front skeletal section of the drag plate body.

7. The drag plate attachment for skid steer machines as claimed in claim 1 comprises:
a pair of supporting arms;
the pair of supporting arms being oppositely positioned of the skid steer mounting plate about the first frame; and
the pair of supporting arms being angularly connected in between the first frame and the second frame.
